(19) United States
(12) Patent Application Publication
(10) Pub. No.: US 2014/0045097 A1
(43) Pub. Date: Feb. 13, 2014

(54) CURRENT COLLECTOR FOR SOLID OXIDE FUEL CELL AND SOLID OXIDE FUEL CELL HAVING THE SAME

(71) Applicant: SAMSUNG ELECTRO-MECHANICS CO., LTD., Suwon (KR)

(72) Inventors: Kyong Bok Min, Suwon (KR); Bon Seok Koo, Suwon (KR); Hong Ryul Lee, Suwon (KR)

(73) Assignee: SAMSUNG ELECTRO-MECHANICS CO., LTD., Suwon (KR)

(21) Appl. No.: 13/717,619

(22) Filed: Dec. 17, 2012

(30) Foreign Application Priority Data
Aug. 10, 2012 (KR) 10-2012-0087748

(51) Int. Cl. H01M 8/02

(52) U.S. Cl. CPC H01M 8/0254
USPC 429/517

(57) ABSTRACT

Disclosed herein is a metal current collector for a solid oxide fuel cell including: a plurality of supports in one direction having a length part extended in one direction; a plurality of supports in another direction having a length part extended in a direction different from that of the support in one direction; and a plurality of pores enclosed by the supports in one direction and the support in another direction that are arranged to intersect with each other, wherein the support is provided with a cutting part so that the length part thereof is not integrally connected.

### CROSS REFERENCE TO RELATED APPLICATION

This application claims the benefit of Korean Patent Application No. 10-2012-0087748, filed on Aug. 10, 2012, entitled “Current Collector for Solid Oxide Fuel Cell and Solid Oxide Fuel Cell Having the Same”, which is hereby incorporated by reference in its entirety into this application.

### BACKGROUND OF THE INVENTION

1. Technical Field

The present invention relates to a current collector for a solid oxide fuel cell and a solid oxide fuel cell having the same.

2. Description of the Related Art

Generally, a fuel cell is a device directly converting chemical energy of fuel (hydrogen, liquefied natural gas (LNG), liquefied petroleum gas (LPG), or the like) and oxygen (air) into electrical and thermal energy by an electrochemical reaction. The existing power generation technologies should perform processes such as fuel combustion, steam generation, turbine driving, generator driving, or the like, while the fuel cell does not need to perform processes such as fuel combustion, turbine driving, or the like. As a result, the fuel cell is a new power generation technology capable of increasing power generation efficiency without causing environmental problems. The fuel cell minimally discharges air pollutants such as SO_{X}, NO_{X}, or the like, and generates less carbon dioxide, such that chemical-free, low-noise, non-vibration power generation, or the like, may be implemented.

There are various types of fuel cells such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like. Among them, the solid oxide fuel cell (SOFC) depends on activation polarization, which lowers over-voltage and irreversible loss to increase power generation efficiency. Further, since the reaction rate in electrodes is rapid, the SOFC does not need expensive precious metals as an electrode catalyst. Therefore, the solid oxide fuel cell is an essential power generation technology in order to enter a hydrogen economy society in the future.

A method of manufacturing porous metal oxide foam for a cathode current collector of a solid oxide fuel cell stack is disclosed in Patent Document 1, wherein a net (for example, Pt mesh current collector) made of precious metals is arranged between the cathode and a separation plate.

Generally, in the solid oxide fuel cell according to the prior art, a unit cell may be damaged due to an increase in its own load at the time of assembling a stack. Therefore, a mesh-type current collector suggested in Patent Document 1 is used in the solid oxide fuel cell to serve as a buffering member reducing a load applied to the unit cell by the load at the time of assembling the stack. In addition, the mesh-type current collector may improve electrical contact between the separation plate and the cathode.

Currently, a mesh-type current collector capable of improving buffering action and current collection has been developed. However, when a metal current collector is exposed at a high temperature for a long period time, generally stress is increased in the metal current collector and contact resistance at a contact portion with the cathode is increased, such that performance of the solid oxide fuel cell may be deteriorated.

### PRIOR ART DOCUMENT

### Patent Document

(Patent Document 1) Korean Patent Laid-open Publication No. 10-0797048

### SUMMARY OF THE INVENTION

The present invention has been made in an effort to provide a metal current collector having a corrugated mesh structure in which internal stress deformation may be minimized, and a solid oxide fuel cell having the same.

As described above, an object of the present invention is to provide a metal current collector capable of minimize internal stress deformation, and a solid oxide fuel cell stacked in a stack state using the metal current collector.

According to a preferred embodiment of the present invention, there is provided a metal current collector for a solid oxide fuel cell including: a plurality of supports in one direction having a length part extended in one direction; a plurality of supports in another direction having a length part extended in a direction different from that of the support in one direction; and a plurality of pores enclosed by the support in one direction and the support in another direction that are arranged to intersect with each other, wherein the support is provided with a cutting part so that the length part is not integrally connected.

The length part of the support in one direction may be provided with the cutting part at which the length part thereof is not integrally connected but disconnected.

The length part of the support in another direction may be provided with the cutting part at which the length part thereof is not integrally connected but disconnected.

The support in one direction may be corrugated in a wave shape in a length direction.

The support in another direction may be corrugated in a wave shape in a length direction.

According to another preferred embodiment of the present invention, there is provided a solid oxide fuel cell including: a unit cell including an anode, an electrode, and a cathode; separation plates including channels formed at an upper or lower surface thereof so as to supply gas and arranged in parallel with each other by a predetermined interval; and a cathode current collector disposed between the separation plate and the cathode of the unit cell and having a mesh structure.

Preferably, the cathode current collector may be corrugated in a wave shape in a length direction and include at least one cutting part at which the support is cut.

Particularly, the cathode current collector may include: a plurality of supports in one direction including a cutting part partially formed at a length part thereof; a plurality of supports in another direction corrugated in a wave shape in a length part; and a plurality of pores enclosed by the support in one direction and the support in another direction that are arranged to intersect with each other.

In other words, the solid oxide fuel cell described above may include the cathode current collector having a corrugated mesh structure.

Selectively, the length part of the support in another direction may be provided with a cutting part.

In addition, the solid oxide fuel cell may further include an anode current collector disposed between the separation plate and the cathode of the unit cell and having a mesh structure.

Preferably, the anode current collector may include: a plurality of supports in one direction corrugated in a wave shape in a length direction and including a cutting part partially formed at a length part thereof; a plurality of supports in another direction corrugated in a wave shape in a length direction; a plurality of pores enclosed by the support in one direction and the support in another direction that are arranged to intersect with each other.

In other words, the solid oxide fuel cell may include the anode current collector having a corrugated mesh structure.

Selectively, the length part of the support in another direction may be provided with a cutting part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a metal current collector having a corrugated mesh structure according to a preferred embodiment of the present invention;

FIG. 2 is a cross-sectional view showing a portion of the metal current collector taken along line A-A of FIG. 1;

FIG. 3 is a perspective view showing a metal current collector having a corrugated mesh structure according to another preferred embodiment of the present invention; and

FIG. 4 is an exploded perspective view of a solid oxide fuel cell using the metal current collector according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

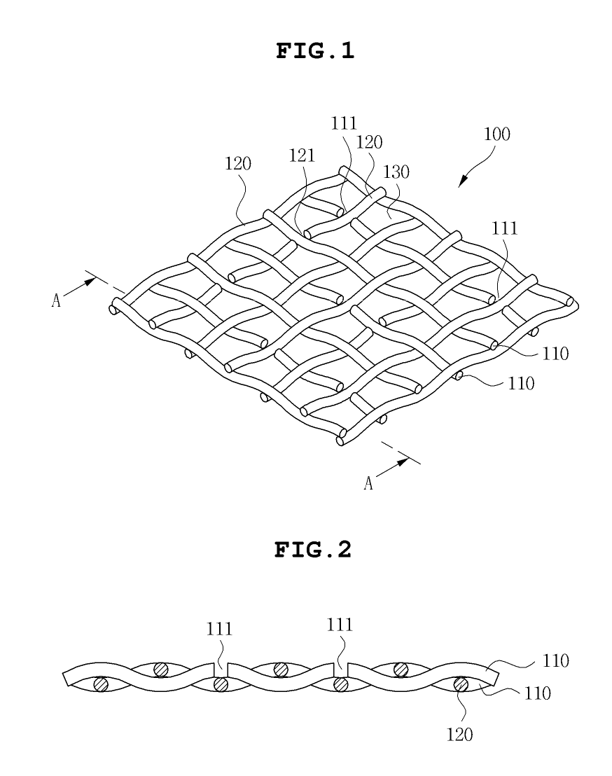

FIG. 1 is a perspective view showing an example of a metal current collector having a corrugated mesh structure according to a preferred embodiment of the present invention, and FIG. 2 is a cross-sectional view showing a portion of the metal current collector taken along line A-A of FIG. 1.

Referring to FIGS. 1 and 2, the metal current collector 100 for a solid oxide fuel cell according to the preferred embodiment of the present invention is woven in a mesh structure in which at least one support 110 in one direction and at least one support 120 in another direction are arranged to intersect with each other so as to have pores 130 via the supports 110 and 120. This metal current collector 100 is formed with a plurality of pores 130 enclosed by the supports 110 in one direction and the supports 120 in another direction as described above, wherein these pores 130 may supply uniform gas to a surface of an electrode (for example, cathode) to reduce polarization resistance.

The metal current collector 100 may be made of a material that is not physically and chemically deformed even in the case in which the material is exposed time at a high temperature of 600° C. or more, under oxidizing atmosphere, and reducing atmosphere for a long period.

Preferably, the metal current collector 100 according to the preferred embodiment of the present invention has a corrugated mesh structure corrugated three-dimensionally rather than a flat mesh structure. As shown in FIG. 1, the support 110 in one direction is corrugated in a wave shape in a length direction, and at the same time, the support 120 in another direction is corrugated in a wave shape in a length direction.

The metal current collector 100 having the corrugated mesh structure has a predetermined height due to crests and troughs of the support 110 in one direction and the support 120 in another direction, and load to be applied to a unit cell in the solid oxide fuel cell having a stack structure may be buffered by this height.

Particularly, the metal current collector 100 having the mesh structure includes at least one cutting part 111 and 121. For example, the current collector 100 according to the present invention include at least one cutting part 111 at the support 110 in one direction and at least one cutting part 121 at the support 120 in another direction. The cutting part of the metal current collector 100 is not limited to having a pattern shown in FIGS. 1 and 2, but may have a random arrangement pattern.

Preferably, the cutting parts 111 and 121 of the metal current collector 100 according to the present invention may be formed at the crests and troughs of the support 110 in one direction and/or the support 120 in another direction, and more preferably, at intersection points between the support 110 in one direction and the support 120 in another direction. The cutting parts 111 and 121 arranged as described above may not hinder a flow of gas penetrating through the pore 130 of the metal current collector 100 but allow the gas to flow together with laminar flow.

In addition, the cutting parts 111 and 121 are formed at an internal portion of the metal current collector 100 except for an edge thereof.

Generally, the current collector is deformed by thermal stress during a process of generating current at a high temperature environment to generate a crack therein, such that resistance loss may be increased due to this crack. However, the cutting parts 111 and 121 of the metal current collector 100 according to the present invention disperse thermal stress generated in the current collector 100 to prevent a crack of the metal current collector 100 in advance, such that durability of the current collector may be improved. Therefore, durability of the metal current collector 100 according to the present invention may be improved to increase current collection efficiency. In addition, the cutting part 111 and 121 as well as the pore 130 may be used as a passage of gas, for example, air, to improve a flow of air. The metal current collector 100 supports the electrode, for example, the cathode while contacting the cathode at the crests and troughs of the support in one direction and/or the support in another direction except for the pore 130 and the cutting parts 111 and 121.

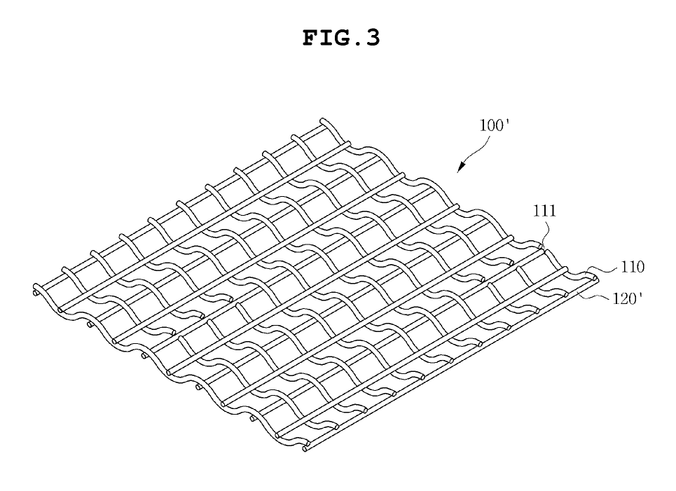

FIG. 3 is a perspective view showing a metal current collector having a corrugated mesh structure according to another preferred embodiment of the present invention.

The metal current collector 100′ according to another preferred embodiment of the present invention is woven by arranging supports 110 in one direction and supports 120′ in another direction to intersect with each other.

The support 110 in one direction is corrugated in a wave shape in a length direction, but the support 120′ in another direction is formed in a straight line shape.

In addition, the support 110 in one direction and the support 120′ in another direction include at least one cutting part 111, similarly to the metal current collector shown in FIG. 1.

In the metal current collector 100′ according to the present invention, a length part of the support 120′ in another direction may be provided with a cutting part (not shown), as needed.

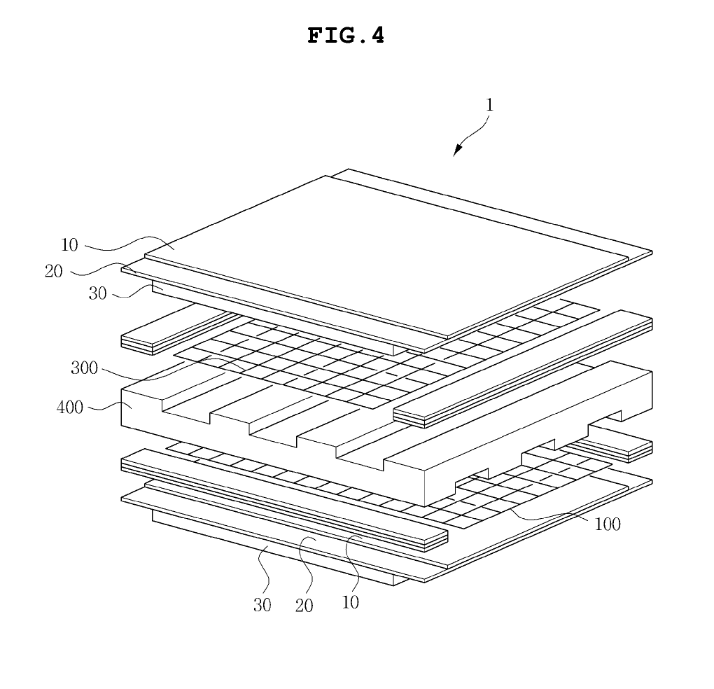

FIG. 4 is an exploded perspective view of a solid oxide fuel cell using the metal current collector according to the preferred embodiment of the present invention. The solid oxide fuel cell 1 shown in FIG. 4, which is a flat plate type solid oxide fuel cell, is configured of a unit cell (no reference numeral) in which a cathode 10, an electrolyte 20, and an anode 30 that are formed in a flat plate shape are sequentially stacked.

More specifically, the solid oxide fuel cell 1 according to the present invention is configured to include at least one unit cell, a cathode current collector 100, and a separation plate 400. Particularly, the separation plate 400 includes channels in order to supply air to the unit cell.

The separation plate 400 is a constituent member capable of electrically connecting an anode of a unit cell to a cathode of another unit cell arranged to be adjacent to each other but to physically blocking air supplied to the cathode from fuel gas supplied to the anode.

The unit cell serves to generate electric energy and is formed by stacking the cathode 10, the electrolyte 20, and the anode 30 therein as described above. Generally, in the solid oxide fuel cell 1 (SOFC), when fuel gas is hydrogen (H2) or carbon monoxide (CO), the following electrode reaction is performed in the cathode 10 and the anode 30.

Cathode: O₂+4e⁻→2O²⁻

Anode: CO+H₂O→H₂+CO₂

2H₂+2O²⁻→4e⁻+2H₂O

Entire reaction: H₂+CO+O₂→CO₂+H₂O

That is, oxygen ions (O²⁻) generated in the cathode 10 are transferred to the anode 30 through the electrolyte 20, and at the same time electrons (e⁻) generated in the anode 30 are transferred to the cathode 10 through an external circuit (not shown). In the anode 30, hydrogen is bonded to oxygen ions to generate electrons and water. As a result, reviewing the entire reaction of the solid oxide fuel cell, hydrogen (H₂) or carbon monoxide (CO) are supplied to the anode 30 and oxygen is supplied to the cathode 10, such that carbon dioxide (CO₂) and water (H₂O) are finally generated.

The cathode 10 receives oxygen or air from an air channel of the separation plate 400 to serve as a cathode through an electrode reaction. Here, the cathode 10 may be formed by sintering lanthanum strontium manganite ((La_{0.84}Sr_{0.16}) MnO₃) having high electron conductivity, or the like. Meanwhile, in the cathode 10, oxygen is converted into oxygen ion by a catalytic reaction of lanthanum strontium manganite to thereby be transferred to the anode 30 through the electrolyte 20.

The electrolyte 20, which is a medium transferring oxygen ions generated in the cathode 10 to the anode 30, may be formed by sintering yttria stabilized zirconia or scandium stabilized zirconia (ScSZ), gadolinia-doped ceria (GDC), La₂O₃-Doped CeO₂ (LDC), or the like. For reference, since tetravalent zirconium ions are partially substituted with trivalent yttrium ions in the yttria stabilized zirconia, one oxygen hole per two yttrium ions is generated therein, and oxygen ions move through the hole at a high temperature. In addition, when pores are generated in the electrolyte 20, since a crossover phenomenon of directly reacting fuel with oxygen (air) may be generated to reduce efficiency, it needs to be noted so that a scratch is not generated.

The anode 30 receives fuel from a fuel channel of the separation plate 400 to serve as an anode through an electrode reaction. Selectively, the anode 30 is configured of nickel oxide (NiO) and yttria stabilized zirconia (YSZ), wherein nickel oxide (NiO) is reduced to metallic nickel by hydrogen to ensure electron conductivity, and yttria stabilized zirconia (YSZ) ensures ion conductivity as oxide.

In the solid oxide fuel cell 1, current is generally collected in a state in which the separation plate does not contact a portion of an area of the electrode, such that current density becomes non-uniform. Therefore, according to the present invention, the solid oxide fuel cell 1 may include cathode current collector 100.

The cathode current collector 100 is loaded between the separation plate 400 and the cathode 10 as shown in FIG. 4.

The solid oxide fuel cell 1 according to the present invention includes the cathode current collector 100 formed of the metal current collector having the corrugated mesh structure described above. The cathode current collector 100 has a structure in which supports in one direction (110 in FIG. 1) and supports in another direction (120 in FIG. 1) are arranged to intersect with each other, wherein the supports in one direction and/or the supports in another direction are formed in a wave shape.

Particularly, the cathode current collector 100 includes at least one cutting part, and more specifically, may include a cutting part at which a length part of the support in one direction and/or the support in another direction is partially cut. This cutting part (no reference numeral) may disperse stress of the collector at the time of operation at a high temperature, thereby making it possible to improve durability of the solid oxide fuel cell 1.

Selectively, the solid oxide fuel cell 1 according to the present invention may further include an anode current collector 300. This anode current collector 300 has a corrugated mesh structure in which supports in one direction and supports in another direction are arranged to intersect with each other, similarly to the cathode current collector 100. The supports in one direction and/or the supports in another direction of the anode current collector 300 are formed of a metal support having a wave shape.

The anode current collector 300 according to the present invention includes at least one cutting part (no reference numeral) formed therein so as to minimize internal stress deformation. This anode current collector 300 is loaded between the separation plate 400 and the anode 30 as shown in FIG. 4.

For reference, the corrugated mesh structure having a wave shape is simply drawn by a straight mesh structure in FIG. 4 in order to more clearly show the cutting part of the cathode current collector 100 and/or the cutting part of the anode current collector 300.

As set forth above, according to the present invention, sheet resistance loss of the solid oxide fuel cell may be minimized and durability thereof may be improved.

Particularly, according to the present invention, contact resistance loss between the cathode and the cathode current collector corresponding to ⅔ of the entire sheet resistance loss may be minimized.

Further, with the current collector according to the present invention, current collecting performance and durability may be secured while minimizing contact resistance loss between the electrode and the current collector.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A current collector for a solid oxide fuel cell comprising:
a plurality of supports in one direction having a length part extended in one direction;
a plurality of supports in another direction having a length part extended in a direction different from that of the support in one direction;
a plurality of pores enclosed by the supports in one direction and the supports in another direction that are arranged to intersect with each other; and
at least one cutting part provided in the support.

2. The current collector for a solid oxide fuel cell as set forth in claim 1, wherein the length part of the support in one direction is provided with the cutting part at which the length part thereof is not integrally connected but disconnected.

3. The current collector for a solid oxide fuel cell as set forth in claim 1, wherein the length part of the support in another direction is provided with the cutting part at which the length part thereof is not integrally connected but disconnected.

4. The current collector for a solid oxide fuel cell as set forth in claim 1, wherein the support in one direction is corrugated in a wave shape in a length direction.

5. The current collector for a solid oxide fuel cell as set forth in claim 1, wherein the support in another direction is corrugated in a wave shape in a length direction.

6. The current collector for a solid oxide fuel cell as set forth in claim 1, wherein the cutting part is formed at an internal portion of the current collector except for an edge thereof.

7. A solid oxide fuel cell comprising:
a unit cell including an anode, an electrode, and a cathode;
at least two separation plates including channels formed at an upper or lower surface thereof so as to supply gas and arranged in parallel with each other by a predetermined interval; and
a cathode current collector disposed between the separation plate and the cathode of the unit cell and having a mesh structure.

8. The solid oxide fuel cell as set forth in claim 7, wherein the cathode current collector includes:
a plurality of supports in one direction corrugated in a wave shape in a length direction;
a plurality of supports in another direction corrugated in a wave shape in a length direction;
a plurality of pores enclosed by the supports in one direction and the supports in another direction that are arranged to intersect with each other; and
a cutting part formed at a length part of the support.

9. The solid oxide fuel cell as set forth in claim 7, wherein the cathode current collector has a corrugated mesh structure.

10. The solid oxide fuel cell as set forth in claim 8, wherein the length part of the support in one direction is provided with a cutting part.

11. The solid oxide fuel cell as set forth in claim 8, wherein the length part of the support in another direction is provided with a cutting part.

12. The solid oxide fuel cell as set forth in claim 7, further comprising an anode current collector disposed between the separation plate and the cathode of the unit cell and having a mesh structure.

13. The solid oxide fuel cell as set forth in claim 12, wherein the anode current collector includes:
a plurality of supports in one direction corrugated in a wave shape in a length direction;
a plurality of supports in another direction corrugated in a wave shape in a length direction;
a plurality of pores enclosed by the supports in one direction and the supports in another direction that are arranged to intersect with each other; and
a cutting part formed at a length part of the supports.

14. The solid oxide fuel cell as set forth in claim 12, wherein the anode current collector has a corrugated mesh structure.

15. The solid oxide fuel cell as set forth in claim 12, wherein the length part of the support in one direction is provided with a cutting part.

16. The solid oxide fuel cell as set forth in claim 12, wherein the length part of the support in another direction is provided with a cutting part.
